(19) United States
(12) Patent Application Publication
(10) Pub. No.: US 2021/0193097 A1
(43) Pub. Date: Jun. 24, 2021

(54) WESTERN AND NATIONAL ENSEMBLE INSTRUMENT

(71) Applicant: Shenzhen Konix Technology Co.,Ltd., Shenzhen (CN)

(72) Inventor: XINHONG KANG, SHENZHEN (CN)

(73) Assignee: Shenzhen Konix Technology Co.,Ltd.

(21) Appl. No.: 16/815,524

(22) Filed: Mar. 11, 2020

(30) Foreign Application Priority Data
Dec. 23, 2019 (CN) 201911400474.4

(51) Int. Cl. G10H 1/18; G10H 1/00; G10H 1/34; G10H 7/00; G10H 1/46

(52) U.S. Cl. CPC G10H 1/185; G10H 2230/241; G10H 1/344; G10H 7/008; G10H 1/46; G10H 1/0066; G10H 2220/221; G10H 2230/065; G10H 2230/255; G10H 2230/195; G10H 2230/135; G10H 2230/245; G10H 2230/085; G10H 2230/175; G10H 2230/181; G10H 2230/185; G10H 2230/221; G10H 2230/225; G10H 1/0008

(57) ABSTRACT

The invention discloses a western and national ensemble instrument which comprises an instrument body, and a key assembly, a matrix circuit, a main board, a function control device and a timbre control device arranged on the instrument body; the key assembly is electrically connected with the matrix circuit; the matrix circuit is electrically connected with the main board; the main board is electrically connected with the function control device; the main board comprises an electrically connected timbre device packaged with a plurality of western musical instrument timbres and a plurality of national opera timbres. Due to the fact that the timbre control device is arranged on the panel of the instrument body, the timbre control device is electrically connected with the function control device by the main board to invoke timbre information corresponding control and any matching and superposition control.

### CROSS-REFERENCE TO RELATED APPLICATIONS

This application claims priority to Chinese Patent Application No. 201911400474.4 with a filing date of Dec. 23, 2019. The content of the aforementioned application, including any intervening amendments thereto, are incorporated herein by reference.

### TECHNICAL FIELD

The invention relates to the technical field of musical instrument equipment, in particular to a band ensemble instrument.

### BACKGROUND ART

The existing digital pianos usually make monotonous sounds. Some electric pianos with high price not only can provide the piano timbre in a professional performance, but also are provided with wind music, string music and other multiple timbres. The overlapping function can play two timbres at the same time, and the dividing function can divide the keyboard into two parts to play two different timbres respectively, but cannot overlap more than three different timbre combination performances. The solo and ensemble functions cannot be realized in the process of overlapping multiple timbres, so that effects of one band cannot be achieved in playing. Not only in entertainment, but also in a performance, an electric piano produces thin and monotonous sounds, lacks rich and thick sound production effects, is bulky and heavy in size, and is extremely inconvenient to move. Therefore, the invention aims to provide an ensemble instrument which is convenient to use and can be overlapped and combined by a plurality of musical instruments. The invention not only can play the piano, but also can play the traditional opera and national music, as well as achieve the overlapped and combined playing of western musical instruments. It has small size, low cost, and can get the band sound effects with itself, which is portable and practical.

### SUMMARY OF THE INVENTION

The invention is directed to provide a western and national ensemble instrument which has the advantages of being easy to operate and convenient for overlapping and combining various western and national musical instruments, and solves the problems of monotonous sounds and incapability of superposition operation of various timbres for an existing electronic piano.

In order to achieve the above object, the technical solution adopted by the invention is as follows.

The invention relates to a western and national ensemble instrument which comprises an instrument body, and a key assembly, a matrix circuit, a main board, a function control device and a timbre control device arranged on the instrument body; the key assembly is electrically connected with the matrix circuit; the matrix circuit is electrically connected with the main board; the main board is electrically connected with the function control device; the main board comprises an electrically connected timbre device packaged with a plurality of western musical instrument timbres and a plurality of national opera timbres, and the timbre control device is electrically connected with the main board to control the timbre device.

In a preferred embodiment of the invention, the main board comprises an electrically connected module device; the module device comprises a chip module, a key scanning chip module, an audio power amplification chip module, a Bluetooth chip module, a MIDI module, an LED driving module, a functional IO module, an analog multiplexer module, a power supply module and a power supply voltage stabilizer module.

In a preferred embodiment of the invention, the instrument body is provided with a timbre control device; the timbre control device is provided with a plurality of groups of timbres, wherein the first group of timbres has a piano timbre, a Marimba timbre, a flute timbre and a Jinghu timbre; the second group has an accordion timbre, an acoustic guitar timbre, a dulcimer timbre and a Chung-hu timbre; the third group has an electric guitar timbre, a bass timbre, a Pan-hu timbre and a Kao-hu timbre; the fourth group has a violin timbre, a violoncello timbre, a Er-hu timbre and a San-hsuan timbre; the fifth group has a string music team timbre, an orchestral music timbre, a So-na timbre and a Cheng timbre; the sixth group has a trumpet timbre, a trombone timbre, a Lusheng timbre and a Pipa timbre; the seventh group has a tuba timbre, a French horn timbre, a saxophone timbre and a Dongxiao timbre; and the eighth group has an oboe timbre, a clarinet timbre, a bass timbre and a cucurbit flute timbre.

In a preferred embodiment of the present invention, the timbre control device is further provided with a timbre selector, a switcher, an ensemble switch, a solo switch, and a volume pusher. The timbre selector invokes the timbre device packaged with a Beijing opera timbre, a Huangmei opera timbre, a Ping opera timbre, a Yue opera timbre, a Henan opera timbre, a Hebei Clapper timbre, a Guangdong opera timbre, a Lei opera timbre, a Sichuan opera timbre and a Kun opera timbre; the timbre control device is electrically connected with the function control device by the main board to invoke timbre information corresponding control and any matching and superposition control; the switcher correspondingly controls the timbre of the current timbre group, and the ensemble switch controls the mute and the ensemble of the timbre corresponding to the current timbre group; the solo switch correspondingly controls the solo and the ensemble of the timbre of the current group; and the volume pusher correspondingly controls the volume of the current timbre.

In a preferred embodiment of the invention, the function control device is provided with a function button, wherein the function button comprises a main volume button, a tune transposition button, a strength button, a record button, a delay button, a speed button, a rhythm button, a play stop button, a synchronization button and an insertion button.

In a preferred embodiment of the invention, the instrument body is provided with a nixie tube display screen, and the timbre control device and the function control device are electrically connected with the main board to display timbre codes for correspondingly controlling switching of the timbre control device and other function tone pitch parameters via the nixie tube display screen.

In a preferred embodiment of the invention, the body further comprises a key assembly provided with a keyboard range zone; the keyboard range zone comprises a melody zone and a low pitch zone; the melody zone has western musical instrument ranges of an A2-C7 piano, an A2-C7 accordion, an A2-C7 electric guitar, an A2-C7 violin, an A2-C7 string music team, an A2-C7 trumpet, an A2-C7 tuba, an A2-C7 oboe, an A2-C7 Marimba, an A2-C7 acoustic guitar, an A2-C7 violoncello, an A2-C7 orchestral music, an A2-C7 trombone, an A2-C7 French horn, an A2-C7 clarinet or range distribution settings of other western musical instruments; the melody zone further has the national musical instrument ranges of an A2-B4 flute, a B2-C6 Yang-chin, an A2-E5 Pan-hu and a B2-E5 Pan-hu effect sound, a Er-hu B2-G5, an A2-D5 So-na and an A2-D5 So-na effect sound, an A2-B5 Lusheng, an A2-C6 saxophone, an E3-G5 Jinghu, an A2-C5 Chung-hu, an A2-C6 Kao-hu, an A2-E5 San-hsuan, an A2-D#6 Cheng, an A2-E5 Pipa, an A2-G4 Dongxiao, an A2-C5 cucurbit flute or range distribution settings of other national musical instruments; and the low pitch zone of the keyboard range zone comprises an A0-G#2 bass, an A0-G#2 piano or range distribution settings of other low-pitch musical instruments.

The invention has the beneficial effects that according to the western and national ensemble instrument provided by the invention, as a plurality of western instrument timbres and a plurality of national instrument timbres are packaged by the timbre device, the timbre control device is electrically connected with the function control device by the main board to invoke timbre information corresponding control and any matching and superposition control, so that the effect of playing by multiple persons can be realized by one person, not requiring too many persons in the playing; a user can play a traditional opera and national music, play a piano, and also other western instruments. More than eight or more timbre combinations can be superposed on the western and national ensemble instrument, saving the cost of purchasing a plurality of musical instruments and improving the musical instrument effect. Furthermore, the instrument is portable and practical.

### BRIEF DESCRIPTION OF THE DRAWINGS

The present invention will now be described in further detail with reference to the accompanying drawings and detailed description.

FIG. 1 is a structurally schematic view of the present invention;

FIG. 2 is a structurally schematic view of a timbre control device of the present invention;

FIG. 3 is a structure block diagram of an instrument body of the present invention

FIG. 4 is a schematic diagram of the range of a western musical instrument of the present invention;

FIG. 5 is a schematic diagram of the range of a national musical instrument of the present invention;

In the drawings: 1—instrument body, 2—key assembly, 3—matrix circuit, 4—main board, 5—function control device, 6—timbre control device, 7—timbre device, 8—module device, 9—function button, 10—timbre selector, 11—switcher, 12—ensemble switch, 13—solo switch, 14—volume pusher, 15—nixie tube display screen, 16—keyboard range zone, 17—melody zone, 18—low pitch zone.

### DETAILED DESCRIPTION OF THE INVENTION

The technical solutions in the embodiments of the present invention will now be described more clearly and fully hereinafter with reference to the accompanying drawings in the embodiments of the present invention. Obviously, the embodiments described are only a part of and not all of the embodiments in the invention. Based on the embodiments of the present invention, all other embodiments obtained by a person skilled in the art without involving any inventive effort are within the scope of the present invention.

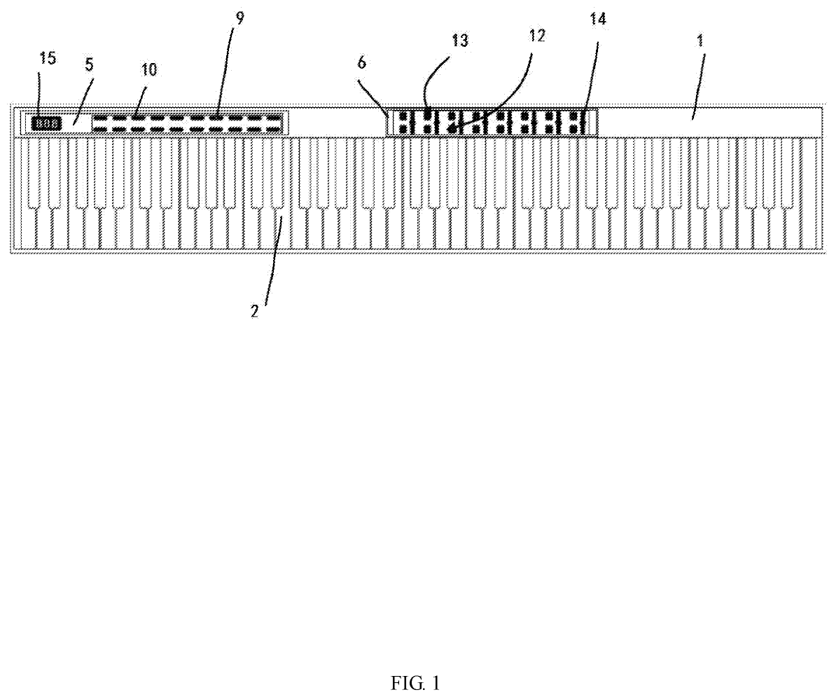

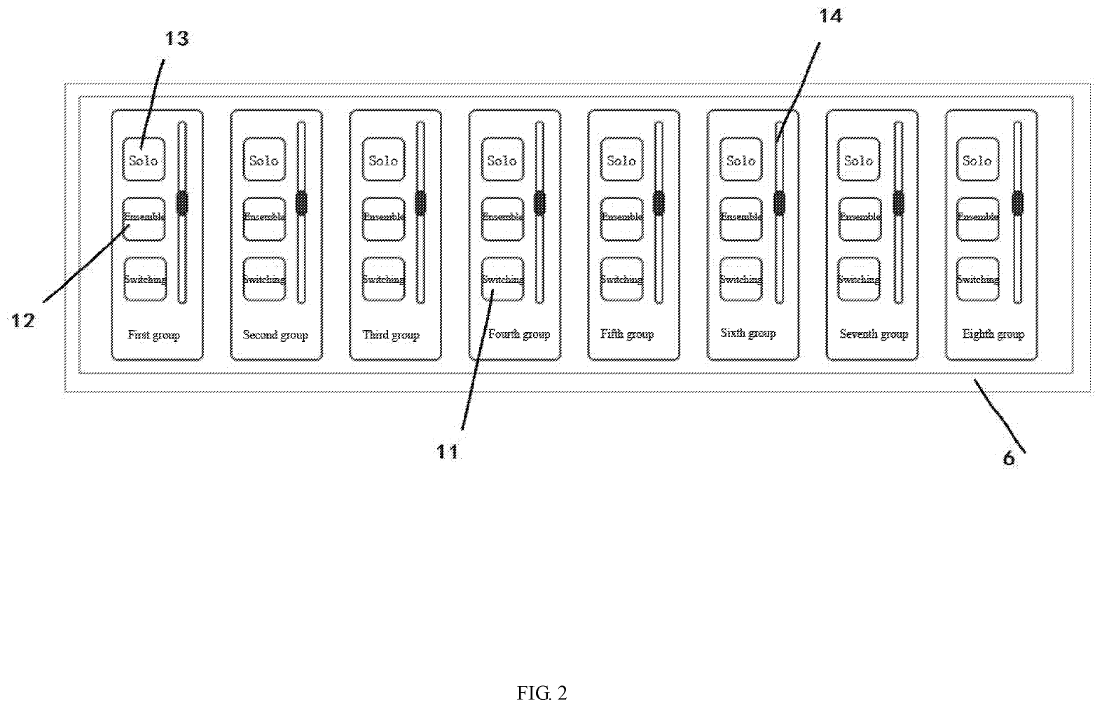

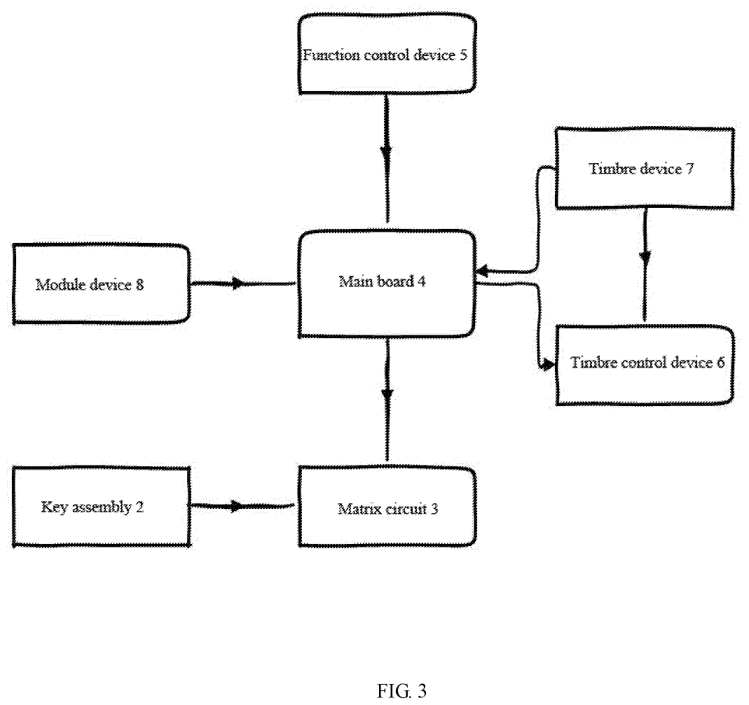

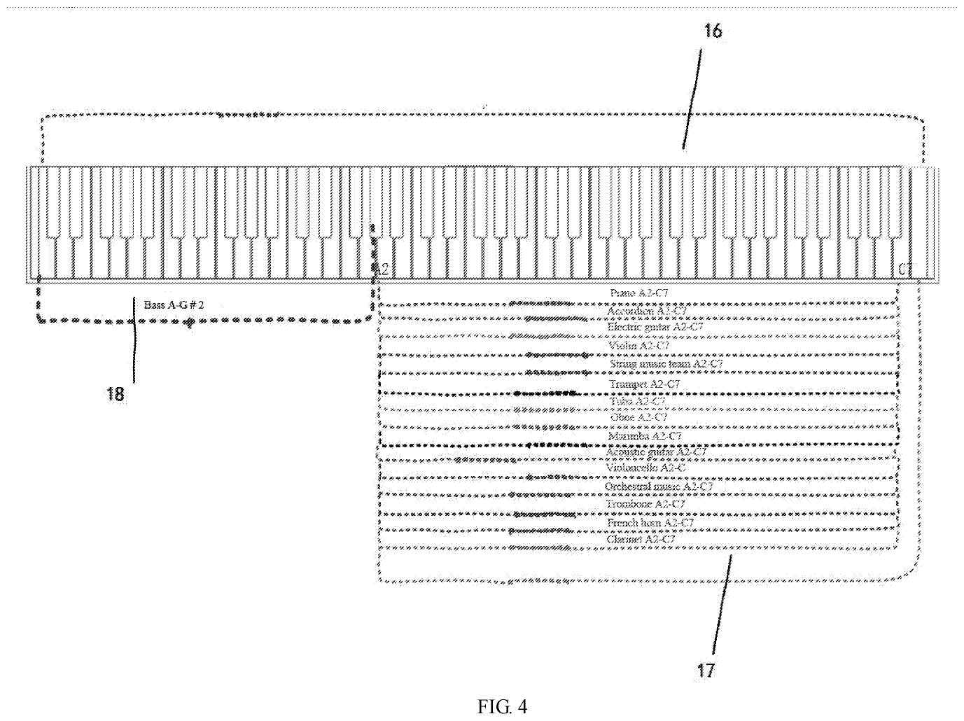

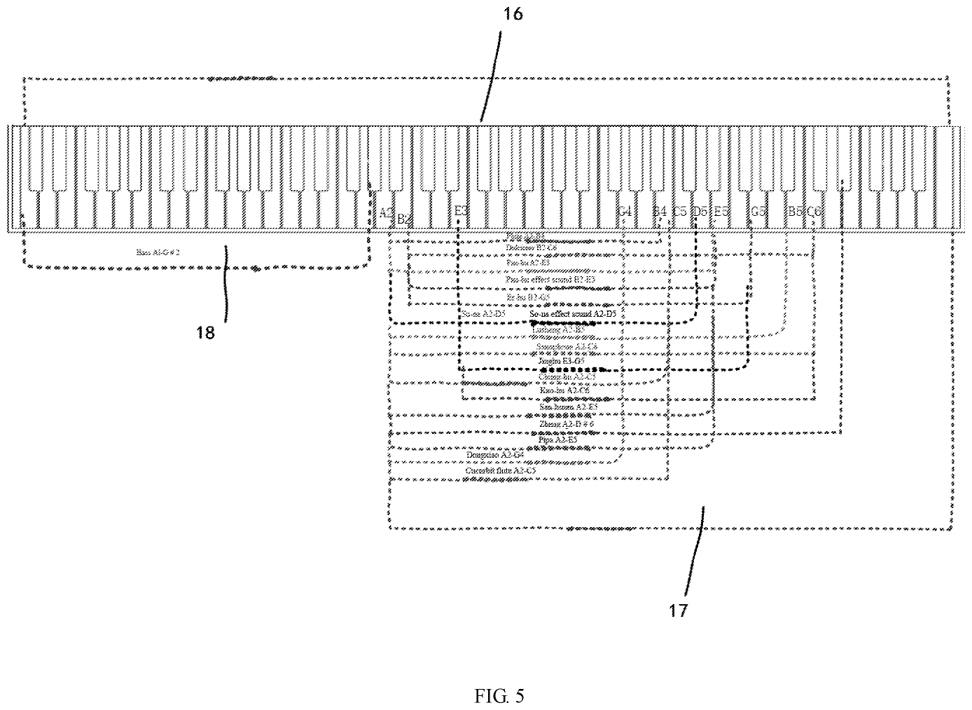

As shown in FIGS. 1, 2, 3, 4 and 5, a western and national ensemble instrument comprises an instrument body 1, and a key assembly 2, a matrix circuit 3, a main board 4, a function control device 5 and a timbre control device 6 arranged on the instrument body 1; the key assembly 2 is electrically connected with the matrix circuit 3; the matrix circuit 3 is electrically connected with the main board 4; the main board 4 is electrically connected with a function control device 5; the main board 4 comprises an electrically connected timbre device 7 packaged with a plurality of western musical instrument timbres and a plurality of national opera timbres, and the timbre control device 6 is electrically connected with the main board 4 to control the timbre device 7. The board 4 comprises an electrically connected module device 8; the module device 8 comprises a chip module, a key scanning chip module, an audio power amplification chip module, a Bluetooth chip module, a MIDI module, an LED driving module, a functional IO module, an analog multiplexer module, a power supply module and a power supply voltage stabilizer module.

Furthermore, the instrument body 1 is provided with a timbre control device 6; the timbre control device 6 is provided with a plurality of groups of timbres, wherein the first group of timbres has a piano timbre, a Marimba timbre, a flute timbre and a Jinghu timbre; the second group has an accordion timbre, an acoustic guitar timbre, a dulcimer timbre and a Chung-hu timbre; the third group has an electric guitar timbre, a bass timbre, a Pan-hu timbre and a Kao-hu timbre; the fourth group has a violin timbre, a violoncello timbre, a Er-hu timbre and a San-hsuan timbre; the fifth group has a string music team timbre, an orchestral music timbre, a So-na timbre and a Cheng timbre; the sixth group has a trumpet timbre, a trombone timbre, a Lusheng timbre and a Pipa timbre; the seventh group has a tuba timbre, a French horn timbre, a saxophone timbre and a Dongxiao timbre; and the eighth group has an oboe timbre, a clarinet timbre, a bass timbre and a cucurbit flute timbre.

Further, the timbre control device 6 is further provided with a timbre selector 10, a switcher 11, an ensemble switch 12, a solo switch 13, and a volume pusher 14. The timbre selector 10 invokes the timbre device 7 packaged with a Beijing opera timbre, a Huangmei opera timbre, a Ping opera timbre, a Yue opera timbre, a Henan opera timbre, a Hebei Clapper timbre, a Guangdong opera timbre, a Lei opera timbre, a Sichuan opera timbre and a Kun opera timbre; the timbre control device 6 is electrically connected with the function control device 5 by the main board 4 to invoke timbre information corresponding control and any matching and superposition control; the switcher 11 correspondingly controls the timbre of the current timbre group, and the ensemble switch 12 controls the mute and the ensemble of the timbre corresponding to the current timbre group; the solo switch 13 correspondingly controls the solo and the ensemble of the timbre of the current group; and the volume pusher 14 correspondingly controls the volume of the current timbre.

Further, the function control device 5 is provided with a function button 9, wherein the function button 9 comprises a main volume button, a tune transposition button, a strength button, a record button, a delay button, a speed button, a rhythm button, a play stop button, a synchronization button and an insertion button.

Furthermore, the instrument body 1 is provided with a nixie tube display screen 15, and the timbre control device 6 and the function control device 5 are electrically connected with the main board 4 to display timbre codes for correspondingly controlling switching of the timbre control device and other function tone pitch parameters via the nixie tube display screen 15.

Further, the body 1 further comprises a key assembly 2 provided with a keyboard range zone 16; the keyboard range zone comprises a melody zone 17 and a low pitch zone 18; the melody zone 17 has western musical instrument ranges of an A2-C7 piano, an A2-C7 accordion, an A2-C7 electric guitar, an A2-C7 violin, an A2-C7 string music team, an A2-C7 trumpet, an A2-C7 tuba, an A2-C7 oboe, an A2-C7 Marimba, an A2-C7 acoustic guitar, an A2-C7 violoncello, an A2-C7 orchestral music, an A2-C7 trombone, an A2-C7 French horn, an A2-C7 clarinet or range distribution settings of other western musical instruments; the melody zone 17 further has the national musical instrument ranges of an A2-B4 flute, a B2-C6 Yang-chin, an A2-E5 Pan-hu and a B2-E5 Pan-hu effect sound, a Er-hu B2-G5, an A2-D5 So-na and an A2-D5 So-na effect sound, an A2-B5 Lusheng, an A2-C6 saxophone, an E3-G5 Jinghu, an A2-C5 Chung-hu, an A2-C6 Kao-hu, an A2-E5 San-hsuan, an A2-D#6 Cheng, an A2-E5 Pipa, an A2-G4 Dongxiao, an A2-C5 cucurbit flute or range distribution settings of other national musical instruments; and the low pitch zone 18 of the keyboard range zone 16 comprises an A0-G#2 bass, A0-G#2 piano or range distribution settings of other low-pitch musical instruments.

It should be noted that in this document, relational terms such as first and second, and the like are only used to distinguish one entity or operation from another entity or operation without necessarily requiring or implying any such actual relationship or order between such entities or operations. Moreover, the terms “comprising”, “including”, or any other variation thereof, are intended to cover a non-exclusive inclusion, such that a process, a method, an article, or equipment that comprises a list of elements does not include only those elements but may include other elements not expressly listed or inherent to such process, method, article, or equipment.

From the foregoing, it should be understood that the foregoing detailed description of the invention has been presented for purposes of illustration or explanation of the principles of the invention only and is not intended to be limiting of the invention. Thus, any modification, equivalent replacement, improvement, etc. made without departing from the spirit and scope of the present invention shall be included in the protection scope of the present invention. Furthermore, it is intended that the appended claims cover all such variations and modifications falling within the scope and boundary of the appended claims or as the equivalents of such scope and boundary.

I claim:

1. A western and national ensemble instrument comprising an instrument body, and a key assembly, a matrix circuit, a main board, a function control device and a timbre control device arranged on the instrument body; wherein the key assembly is electrically connected with the matrix circuit; the matrix circuit is electrically connected with the main board; the main board is electrically connected with the function control device; the main board comprises an electrically connected timbre device packaged with a plurality of western musical instrument timbres and a plurality of national opera timbres; and the timbre control device is electrically connected with the main board to control the timbre device.

2. The western and national ensemble instrument according to claim 1, wherein the main board comprises an electrically connected module device; the module device comprises a chip module, a key scanning chip module, an audio power amplification chip module, a Bluetooth chip module, a MIDI module, an LED driving module, a functional IO module, an analog multiplexer module, a power supply module and a power supply voltage stabilizer module.

3. The western and national ensemble instrument according to claim 1, wherein the instrument body is provided with a timbre control device; the timbre control device is provided with a plurality of groups of timbres, wherein the first group of timbres has a piano timbre, a Marimba timbre, a flute timbre and a Jinghu timbre; the second group has an accordion timbre, an acoustic guitar timbre, a dulcimer timbre and a Chung-hu timbre;
the third group has an electric guitar timbre, a Bass timbre, a Pan-hu timbre and a Kao-hu timbre; the fourth group has a violin timbre, a violoncello timbre, a Er-hu timbre and a San-hsuan timbre; the fifth group has a string music team timbre, an orchestral music timbre, a So-na timbre and a Cheng timbre; the sixth group has a trumpet timbre, a trombone timbre, a Lusheng timbre and a Pipa timbre; the seventh group has a tuba timbre, a French horn timbre, a saxophone timbre and a Dongxiao timbre; and the eighth group has an oboe timbre, a clarinet timbre, a Bass timbre and a cucurbit flute timbre.

4. The western and national ensemble instrument according to claim 1, wherein the timbre control device is further provided with a timbre selector, a switcher, an ensemble switch, a solo switch, and a volume pusher; the timbre selector invokes the timbre device packaged with a Beijing opera timbre, a Huangmei opera timbre, a Ping opera timbre, a Yue opera timbre, a Henan opera timbre, a Hebei Clapper timbre, a Guangdong opera timbre, a Lei opera timbre, a Sichuan opera timbre and a Kun opera timbre; the timbre control device is electrically connected with the function control device by the main board to invoke timbre information corresponding control and any matching and superposition control; the switcher correspondingly controls the timbre of the current timbre group, and the ensemble switch controls the mute and the ensemble of the timbre corresponding to the current timbre group;
the solo switch correspondingly controls the solo and the ensemble of the timbre of the current group; and the volume pusher correspondingly controls the volume of the current timbre.

5. The western and national ensemble instrument according to claim 1, wherein the function control device is provided with a function button, wherein the function button comprises a main volume button, a tune transposition button, a strength button, a record button, a delay button, a speed button, a rhythm button, a play stop button, a synchronization button and an insertion button.

6. The western and national ensemble instrument according to claim 1, wherein the instrument body is provided with a nixie tube display screen, and the timbre control device and the function control device are electrically connected with the main board to display timbre codes for correspondingly controlling switching of the timbre control device and other function tone pitch parameters via the nixie tube display screen.

7. The western and national ensemble instrument according to claim 1, wherein the instrument body further comprises a key assembly provided with a keyboard range zone;
the keyboard range zone comprises a melody zone and a low pitch zone; the melody zone has western musical instrument ranges of an A2-C7 piano, an A2-C7 accordion, an A2-C7 electric guitar, an A2-C7 violin, an A2-C7 string music team, an A2-C7 trumpet, an A2-C7 tuba, an A2-C7 oboe, an A2-C7 Marimba, an A2-C7 acoustic guitar, an A2-C7 violoncello, an A2-C7 orchestral music, an A2-C7 trombone, an A2-C7 French horn, an A2-C7 clarinet or range distribution settings of other western musical instruments; the melody zone further has the national musical instrument ranges of an A2-B4 flute, a B2-C6 Yang-chin, an A2-E5 Pan-hu and a B2-E5 Pan-hu effect sound, a Er-hu B2-G5, an A2-D5 So-na and an A2-D5 So-na effect sound, an A2-B5 Lusheng, an A2-C6 saxophone, an E3-G5 Jinghu, an A2-C5 Chung-hu, an A2-C6 Kao-hu, an A2-E5 San-hsuan, an A2-D#6 Cheng, an A2-E5 Pipa, an A2-G4 Dongxiao, an A2-C5 cucurbit flute or range distribution settings of other national musical instruments; and the low pitch zone of the keyboard range zone comprises an A0-G#2 bass, an A0-G#2 piano or range distribution settings of other low-pitch musical instruments.
